(19) United States
(12) Patent Application Publication
(10) Pub. No.: US 2022/0366629 A1
(43) Pub. Date: Nov. 17, 2022

(54) DELAY MEASUREMENT APPARATUS, DELAY MEASUREMENT METHOD AND PROGRAM

(71) Applicant: Nippon Telegraph and Telephone Corporation, Tokyo (JP)

(72) Inventors: Shinya Tamaki, Musashino-shi, Tokyo (JP); Takeshi KUWAHARA, Musashino-shi, Tokyo (JP); Kenta KAWAKAMI, Musashino-shi, Tokyo (JP); Yusuke URATA, Musashino-shi, Tokyo (JP); Hiroki Iwasawa, Musashino-shi, Tokyo (JP)

(21) Appl. No.: 17/623,964

(22) PCT Filed: Jul. 1, 2019
(86) PCT No.: PCT/JP2019/026092

§ 371 Date: Dec. 30, 2021

(51) Int. Cl. G06T 15/00; G06F 11/34

(52) U.S. Cl. CPC G06T 15/005; G06F 11/34

(57) ABSTRACT

A delay measurement device that is to be connected, via a communication network, to a rendering server that performs rendering processing on an image, includes: transmission means for transmitting, to the rendering server, sensor information acquired from a sensor included in the delay measurement device and trigger information acquired in a predetermined time period; receiving means for receiving a rendered image generated through the rendering processing performed in the rendering server based on the sensor information and the trigger information; and measurement means for measuring a predetermined delay based on a difference between a first time indicating a time when the trigger information was transmitted to the rendering server and a second time indicating a time when the rendered image or a predetermined image was displayed.

### TECHNICAL FIELD

The present invention relates to a delay measurement device, a delay measurement method, and a program.

### BACKGROUND ART

In recent years, with the development of cloud technologies and the spread of high-speed communication environments, there has been an increase in the number of services that perform image rendering processing on the server side and provide images to user terminals. Such services are also called streaming services. The streaming services can provide, for example, various applications such as VR (Virtual Reality) to general-purpose terminals such as smartphones without requiring the user side to have a device equipped with a GPU (Graphics Processing Unit) or the like.

Here, in applications such as VR, a delay between the time when sensor information from a user terminal (e.g., an HDM (Head Mounted Display) etc.) is transmitted to a server and the time when an image from a camera eyepoint based on this sensor information is rendered by the server and displayed on the user terminal (this delay is also called a “motion-to-photon latency” or a “motion-to-photon delay” etc.) significantly affects the quality of the user experience. There are also various other delay factors in addition to this delay, and perceiving these delays is important for the development, construction, maintenance, or the like of services.

As a technology for measuring the motion-to-photon delay, a technology is known by which a measurement device that automatically rotates an HMD is constructed, and a rotation control signal is compared with a follow-up response of variation in the amount of light received by a photodiode to calculate a delay amount (NPL 1). A technology is also known by which a measurement device that simulates a movement of a human head is constructed, and a control signal is compared with a follow-up response of variation in the amount of light received by a photodiode to calculate a delay amount (NPLs 2 and 3).

### CITATION LIST

### Non Patent Literature

[NPL 1] Jingbo Zhao et al., “Estimating the motion-to-photon latency in head mounted displays”, 2017 IEEE Virtual Reality (VR), Mar. 18-22, 2017.
[NPL 2] Song-Woo Choi et al., “Time Sequential Motion-to-Photon Latency Measurement System for Virtual Reality Head-Mounted Displays”, Electronics 2018, 7, 171.
[NPL 3] 4Gamer.net, “Futuremark Released Platform for Measuring Delay in VR at GDC and Mobile World Congress”, February 2017. <URL:http://jp.gamesindustry.biz/article/1702/17022203/>

### SUMMARY OF THE INVENTION

### Technical Problem

However, in the above-described conventional technologies, it is necessary to construct a dedicated measurement device to measure the motion-to-photon delay; for example, it is necessary to construct a measurement device that automatically rotates an HMD or to construct a measurement device that simulates a movement of a human head. Moreover, with the above-described conventional technologies, measurement cannot be conducted while the services are provided, and furthermore, only the motion-to-photon delay can be measured and the breakdown of the delay cannot be analyzed.

Modes for carrying out the present invention have been made in view of the foregoing, and an object of the present invention is to make it possible to simply measure various delays occurring when an image rendered by a rendering server is displayed on a user terminal.

### Means for Solving the Problem

To achieve the above-stated object, in a mode for carrying out the present invention, a delay measurement device that is to be connected, via a communication network, to a rendering server that performs rendering processing on an image, includes: transmission means for transmitting, to the rendering server, sensor information acquired from a sensor included in the delay measurement device and trigger information acquired in a predetermined time period; receiving means for receiving a rendered image generated through the rendering processing performed in the rendering server based on the sensor information and the trigger information; and measurement means for measuring a predetermined delay based on a difference between a first time indicating a time when the trigger information was transmitted to the rendering server and a second time indicating a time when the rendered image or a predetermined image was displayed.

### Effects of the Invention

Various delays occurring when an image rendered by the rendering server is displayed on a user terminal can be simply measured.

### BRIEF DESCRIPTION OF DRAWINGS

FIG. 1 is a diagram for illustrating an example of an overall configuration of a delay measurement system according to Embodiment 1.

FIG. 2 is a diagram for illustrating an example of a functional configuration of the delay measurement system according to Embodiment 1.

FIG. 3 is a diagram for illustrating a flow of delay measurement processing according to Embodiment 1.

FIG. 4 is a diagram for illustrating an example of an image obtained as a rendering result according to Embodiment 1.

FIG. 5 is a diagram for illustrating an example of a delay measurement result according to Embodiment 1.

FIG. 6 is a diagram for illustrating an example of a functional configuration of the delay measurement system according to Embodiment 2.

FIG. 7 is a diagram for illustrating a flow of delay measurement processing according to Embodiment 2.

FIG. 8 is a diagram for illustrating an example of a functional configuration of the delay measurement system according to Embodiment 3.

FIG. 9 is a diagram for illustrating a flow of delay measurement processing according to Embodiment 3.

FIG. 10 is a diagram for illustrating an example of a functional configuration of the delay measurement system according to Embodiment 4.

FIG. 11 is a diagram for illustrating a flow of delay measurement processing according to Embodiment 4.

FIG. 12 is a diagram for illustrating an example of a functional configuration of the delay measurement system according to Embodiment 5.

FIG. 13 is a diagram for illustrating a flow of delay measurement processing according to Embodiment 5.

FIG. 14 is a diagram for illustrating an example of a functional configuration of the delay measurement system according to Embodiment 6.

FIG. 15 is a diagram for illustrating a flow of delay measurement processing according to Embodiment 6.

FIG. 16 is a diagram (part 1) for illustrating an example of an image obtained as a rendering result according to Embodiment 6.

FIG. 17 is a diagram (part 2) for illustrating an example of an image obtained as a rendering result according to Embodiment 6.

FIG. 18 is a diagram for illustrating an example of a functional configuration of the delay measurement system according to Embodiment 7.

FIG. 19 is a diagram showing an example of a hardware configuration of a computer.

### DESCRIPTION OF EMBODIMENTS

Hereinafter, the modes for carrying out the present invention will be described. The modes for carrying out the present invention will describe a delay measurement system 1 that makes it possible to simply measure various delays occurring when an image rendered by a rendering server is displayed on a user terminal. In the modes for carrying out the present invention, various delays can be measured only by adding minimum measurement information (trigger information etc.) to sensor information (main signal, U-plane packet), as will be described later. Thus, for example, various delays can be measured with a low load even in a communication network, a virtualization infrastructure, or the like.

Embodiments 1 to 7 of the delay measurement system 1 in the modes for carrying out the present invention will be described below. Note that, in the embodiments, the same constituent elements are assigned the same reference signs, and description thereof is omitted.

### Embodiment 1

First, a description will be given of the case as Embodiment 1 in which an E2E (End-to-End) delay excluding a delay associated with display on a user terminal (hereinafter also referred to as a “terminal delay”) is measured. Note that the E2E delay refers to a delay between the time when the user terminal transmits sensor information to a rendering server and the time when an image rendered by the rendering server is displayed on the user terminal (i.e., a motion-to photon delay).

(Overall Configuration)

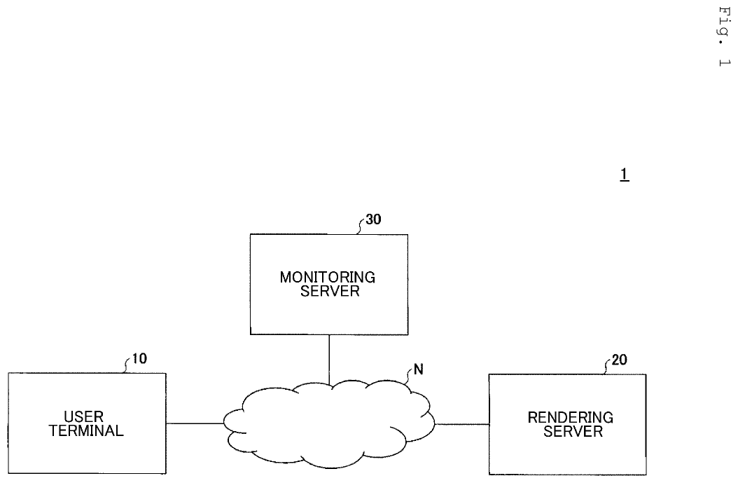

An overall configuration of the delay measurement system 1 according to Embodiment 1 will be described with reference to FIG. 1. FIG. 1 is a diagram for illustrating an example of the overall configuration of the delay measurement system 1 according to Embodiment 1.

As shown in FIG. 1, the delay measurement system 1 according to Embodiment 1 includes a user terminal 10, a rendering server 20, and a monitoring server 30. The user terminal 10, the rendering server 20, and the monitoring server 30 are communicably connected to each other via a communication network N such as the Internet.

The user terminal 10 is a terminal of a user of an application that uses images rendered by the rendering server 20. The user terminal 10 is equipped with various sensors (e.g., a motion sensor etc.), and transmits sensor information acquired from these sensors to the rendering server 20. For example, an HMD, a smartphone, a tablet terminal, a portable game machine, or the like is used as the user terminal 10.

Although there are various applications that use images rendered by the rendering server 20, examples include VR, a game, 3D CAD (Computer Aided Design), or the like.

The rendering server 20 is a computer or a computer system that, upon receiving the sensor information from the user terminal 10, renders an image from a camera eyepoint based on the sensor information. The image rendered by the rendering server 20 (more specifically, information obtained by encoding the rendered image) is transmitted to the user terminal 10 and is displayed on the user terminal 10 (more specifically, displayed on a display provided in the user terminal 10).

The monitoring server 30 is a computer or a computer system for measuring various delays. For example, the results of measuring various delays are displayed on the monitoring server 30. Also, the monitoring server 30 transmits information indicating a measurement mode (measurement mode information) to the user terminal 10.

The measurement mode refers to a mode indicating what kind of delay is measured. In the modes for carrying out the present invention, for example, there are measurement modes such as “measuring E2E delay excluding terminal delay”, “measuring network delay”, and “delay excluding terminal delay and encoding/decoding delay”.

(Functional Configuration)

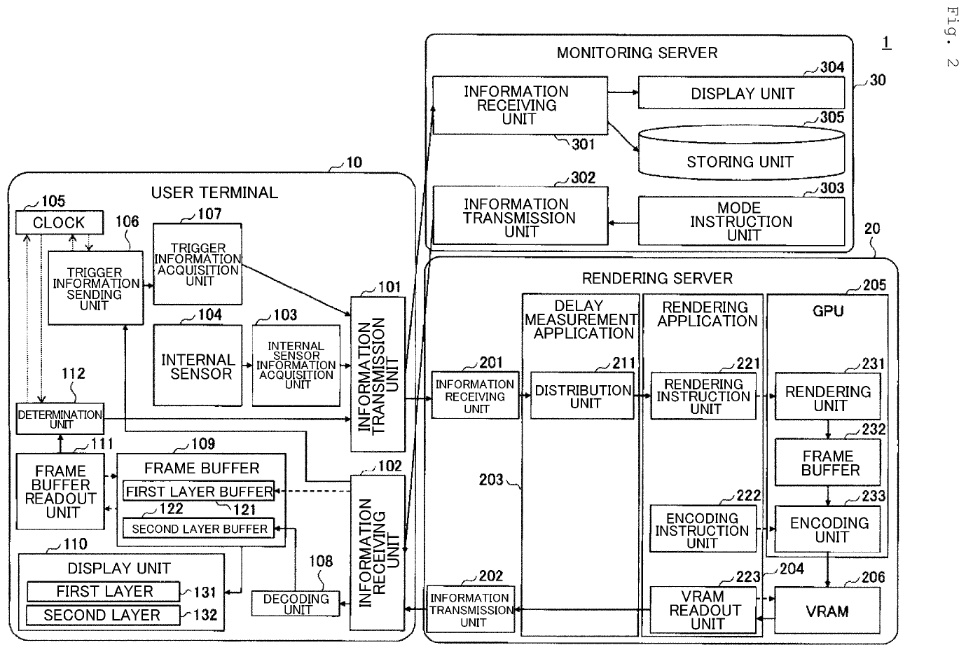

A functional configuration of the delay measurement system 1 according to Embodiment 1 will be described with reference to FIG. 2. FIG. 2 is a diagram for illustrating an example of the functional configuration of the delay measurement system 1 according to Embodiment 1.

As shown in FIG. 2, the user terminal 10 according to Embodiment 1 includes an information transmission unit 101, an information receiving unit 102, an internal sensor information acquisition unit 103, an internal sensor 104, a clock 105, a trigger information sending unit 106, a trigger information acquisition unit 107, a decoding unit 108, a frame buffer 109, a display unit 110, a frame buffer readout unit 111, and a determination unit 112.

The clock 105 is a free-running clock (or a non free-running clock acquired from a GPS (Global Positioning System) or the like). The trigger information sending unit 106 periodically sends out trigger information based on a clock signal from the clock 105. The trigger information acquisition unit 107 acquires the trigger information sent out from the trigger information sending unit 106 (i.e., the trigger information is periodically acquired). Note that the trigger information may also be referred to as a “trigger signal” or the like.

The internal sensor information acquisition unit 103 acquires sensor information from the internal sensor 104. The internal sensor 104 is a sensor that detects the orientation and the position of the user terminal 10, pressing of various buttons, an operation made using a joystick, or the like. Accordingly, the sensor information is, for example, information indicating the direction of the orientation of the user terminal 10, information indicating the position of the user terminal 10, information indicating a button pressed by the user, information indicating the direction in which the joystick has been operated by the user, or the like.

The information transmission unit 101 transmits the trigger information and a time stamp to the monitoring server 30 at a timing at which the trigger information is acquired. Similarly, the information transmission unit 101 transmits the sensor information and the trigger information to the rendering server 20 at the timing at which the trigger information is acquired. Meanwhile, the information transmission unit 101 transmits the sensor information to the rendering server 20 without transmitting the trigger information at a timing at which the trigger information is not acquired.

The information receiving unit 102 receives encoded information (i.e., information obtained by encoding (compressing) a rendered image) from the rendering server 20. Also, the information receiving unit 102 receives the measurement mode information or the like from the monitoring server 30. Here, as will be described later, information obtained by encoding the rendered image, which is an image that has been processed such that a partial region of a portion of the rendered image represents either value of binary information, is transmitted from the rendering server 20.

The decoding unit 108 decodes the encoded information received by the information receiving unit 102. The information decoded by the decoding unit 108 (i.e., the rendered image) is stored in the frame buffer 109.

Here, the display unit 110 of the user terminal 10 is equipped with at least two image display layers, and the two image display layers are a first layer 131 and a second layer 132. The first layer 131 is an image display layer on the outermost surface, and the second layer 132 is an image display layer immediately below the outermost surface layer. The image obtained by decoding the encoded information received from the rendering server 20 is displayed on the second layer 132.

The frame buffer 109 includes a first layer buffer 121 in which an image to be displayed on the first layer 131 is stored, and a second layer buffer 122 in which an image to be displayed on the second layer 132 is stored. The information decoded by the decoding unit 108 (i.e., the rendered image) is stored in the second layer buffer 122.

The display unit 110 reads out an image from the frame buffer 109 and displays this image. As mentioned above, the display unit 110 includes the first layer 131 and the second layer 132.

The frame buffer readout unit 111 reads out a predetermined partial region in an image stored in the frame buffer 109 (more specifically, an image stored in the second layer buffer 122). That is to say, the frame buffer readout unit 111 reads a partial region representing binary information within the rendered image.

Based on the partial region read out by the frame buffer readout unit 111, the determination unit 112 determines the binary information represented by this partial region. That is to say, for example, if the binary information is either “white” or “black”, the determination unit 112 determines whether the partial region represents black or white. Note that the result of this determination and a time stamp are transmitted to the monitoring server 30.

As shown in FIG. 2, the rendering server 20 according to Embodiment 1 includes an information receiving unit 201, an information transmission unit 202, a delay measurement application 203, a rendering application 204, a GPU 205, and a VRAM (Video RAM) 206.

The information receiving unit 201 receives the sensor information, or the sensor information and the trigger information, from the user terminal 10.

The delay measurement application 203 is an application program installed in the rendering server 20 for the purpose of delay measurement. In Embodiment 1, the delay measurement application 203 includes a distribution unit 211. The distribution unit 211 performs distribution in accordance with the measurement mode if the sensor information and the trigger information are received. In Embodiment 1, if the measurement mode is “measuring E2E delay excluding terminal delay”, the distribution unit 211 transmits the sensor information and the trigger information as-is to the rendering application 204.

The rendering application 204 is an application program installed in the rendering server 20 in order to perform rendering. In Embodiment 1, the rendering application 204 includes a rendering instruction unit 221, an encoding instruction unit 222, and a VRAM readout unit 223.

The rendering instruction unit 221 gives a rendering instruction to the GPU 205. At this time, if the sensor information and the trigger information are received from the user terminal 10, the rendering instruction unit 221 gives a rendering instruction to perform processing to change the binary information represented by the predetermined partial region in the image from the eyepoint based on the sensor information (i.e., for example, if the partial region represents “black”, the binary information is changed so as to represent “white”, and if the partial region represents “white”, the binary information is changed so as to represent “black”).

The encoding instruction unit 222 gives an encoding instruction to the GPU 205. The VRAM readout unit 223 reads out encoded information from the VRAM 206.

The GPU 205 is a processor that performs processing such as rendering and encoding. A rendering unit 231 and an encoding unit 233 are realized by the GPU 205 executing processing. The GPU 205 includes a frame buffer 232. However, the frame buffer 232 may be the same hardware as the VRAM 206.

The rendering unit 231 renders an image from an eyepoint based on the sensor information and generates a rendered image in accordance with the rendering instruction from the rendering instruction unit 221. This rendered image is stored in the frame buffer 232.

The encoding unit 233 encodes the rendered image stored in the frame buffer 232 and generates encoded information in accordance with the encoding instruction from the encoding instruction unit 222. The encoded information is stored in the VRAM 206.

The information transmission unit 202 transmits the encoded information read out by the VRAM readout unit 223 to the user terminal 10.

As shown in FIG. 2, the monitoring server 30 according to Embodiment 1 includes an information receiving unit 301, an information transmission unit 302, a mode instruction unit 303, a display unit 304, and a storing unit 305.

The mode instruction unit 303 accepts an instruction of the measurement mode in accordance with an operation made by the user, for example. At this time, the mode instruction unit 303 may accept an instruction of the period in which the trigger information is sent out, for example.

The information transmission unit 302 transmits information indicating the measurement mode (measurement mode information) to the user terminal 10 in accordance with the instruction of the measurement mode accepted by the mode instruction unit 303. Note that if an instruction of the period in which the trigger information is sent out (i.e., a trigger period) is also accepted by the mode instruction unit 303, the information transmission unit 302 also transmits information indicating this period (trigger period information) to the user terminal 10. Thus, the measurement mode (and the period in which the trigger information is sent out) is set to the user terminal 10.

The information receiving unit 301 receives the trigger information and the time stamp (this time stamp will be hereinafter referred to as a “first time stamp”) from the user terminal 10. The information receiving unit 301 also receives the determination result and the time stamp (this time stamp will be hereinafter referred to as a “second time stamp”) from the user terminal 10. The trigger information, the first time stamp, the determination result, and the second time stamp are stored in the storing unit 305.

The display unit 304 displays a delay measurement result using the trigger information, the first time stamp, the determination result, and the second time stamp that are stored in the storing unit 305. The delay measurement result is displayed by plotting, as a graph, the first time stamp and the second time stamp for each determination result (i.e., the second time stamp in the case where the determination result is “black” and the second time stamp in the case where the determination result is “white”), for example.

Note that the functional configuration of the delay measurement system 1 shown in FIG. 2 is an example and may be any other configuration. For example, the functions of the monitoring server 30 may be included in the user terminal 10, or the functions of the monitoring server 30 may be included in the rendering server 20. Alternatively, for example, the functions of the monitoring server 30 may be distributed to a plurality of different nodes.

(Flow of Delay Measurement Processing)

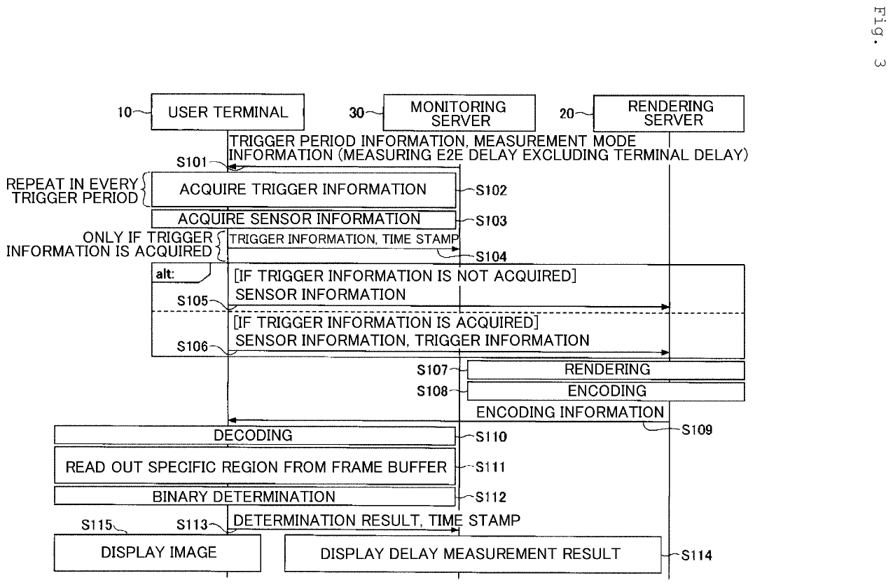

A flow of processing for measuring a delay (delay measurement processing) of Embodiment 1 will be described with reference to FIG. 3. FIG. 3 is a diagram for illustrating a flow of the delay measurement processing according to Embodiment 1.

The information transmission unit 302 of the monitoring server 30 transmits the measurement mode information and the trigger period information to the user terminal 10 in accordance with the instruction of the measurement mode and an instruction of the trigger period accepted by the mode instruction unit 303 (step S101). Here, in Embodiment 1, “measuring E2E delay excluding terminal delay” is set as the measurement mode. Thus, the measurement mode: “measuring E2E delay excluding terminal delay” and the trigger period, which is the period in which the trigger information sending unit 106 sends out the trigger information are set to the user terminal 10.

The trigger information acquisition unit 107 of the user terminal 10 acquires the trigger information that is sent out from the trigger information sending unit 106 in every trigger period (step S102). Note that the trigger period can be set in any manner, and it is conceivable that, for example, the trigger period is set to about 20 [ms] to 1 [s]. When, for example, the trigger period is denoted as T and T=20 [ms], the trigger information is sent out every T=20 [ms] by the trigger information sending unit 106, and thus, the trigger information acquisition unit 107 acquires the trigger information every T=20 [ms].

Note that the trigger information may be any information, and it is conceivable that, for example, the trigger information is information (i.e., a flag) that alternately contains “0” and “1” in every other trigger period.

The internal sensor information acquisition unit 103 of the user terminal 10 acquires the sensor information from the internal sensor 104 (step S103).

If the trigger information is acquired in the above step S102, the information transmission unit 101 of the user terminal 10 transmits the trigger information and the first time stamp to the monitoring server 30 (step S104). Thus, in the monitoring server 30, the trigger information and the first time stamp are stored in association with each other in the storing unit 305. Here, the first time stamp is information indicating, for example, the time when the trigger information was transmitted to the monitoring server 30, and can be acquired from the clock 105, for example.

Note that a configuration may be employed in which if, for example, communication quality between the user terminal 10 and the monitoring server 30 is stable, in the above step S104, the information transmission unit 101 does not transmit the first time stamp, and the first time stamp is generated and stored by the monitoring server 30 when the trigger information is received. Thus, a communication load between the user terminal 10 and the monitoring server 30 can be reduced.

If, in the above step S102, the trigger information is not acquired (e.g., if the sensor information is acquired in the above step S103 after the trigger information has been acquired and before the trigger period elapses), the information transmission unit 101 transmits the sensor information acquired in the above step S103 to the rendering server 20 (step S105).

On the other hand, if, in the above step S102, the trigger information is acquired, the information transmission unit 101 of the user terminal 10 transmits, to the rendering server 20, the sensor information acquired in the above step S103 and the trigger information acquired in the above step S102 (step S106). At this time, the information transmission unit 101 also transmits the measurement mode information to the rendering server 20. Note that the measurement mode information may be included in the trigger information (e.g., a flag indicating the measurement mode may be included in the trigger information).

If the measurement mode is “measuring E2E delay excluding terminal delay”, the distribution unit 211 of the rendering server 20 transmits the information (the sensor information, or the sensor information and the trigger information) received by the information receiving unit 201 as-is to the rendering application 204. Then, the rendering instruction unit 221 of the rendering server 20 gives rendering instructions to the GPU 205 in accordance with the information received by the information receiving unit 201 (step S107). Thus, a rendered image is generated and stored in the frame buffer 232.

Here, if the information receiving unit 201 receives the sensor information and the trigger information (i.e., if the above step S106 is executed), the rendering instruction unit 221 gives, as the rendering instructions, an instruction to generate an image from a camera eyepoint based on the sensor information, and an instruction to perform processing to change binary information represented by the predetermined partial region in this image (i.e., if, for example, the partial region represents “black”, the binary information is changed to represent “white”, and if the partial region represents “white”, the binary information is changed to represent “black”).

On the other hand, if the information receiving unit 201 receives the sensor information (i.e., if the above step S105 is executed), the rendering instruction unit 221 gives, as rendering instructions, an instruction to generate an image from a camera eyepoint based on the sensor information, and gives an instruction to leave binary information represented by the predetermined partial region in this image as-is (i.e., for example, if the partial region represents “black”, the binary information remains representing “black”, and if the partial region represents “white”, the binary information remains representing “white”).

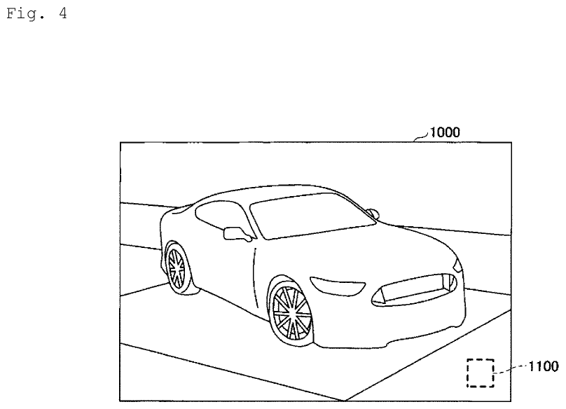

Thus, a rendered image that includes the partial region representing binary information is generated by the rendering unit 231. At this time, the partial region included in this rendered image alternately switches between the partial region representing “white” and the partial region representing “black” every time the trigger information is received. Here, an example of an image (rendered image) obtained as a result of the rendering in the above step S107 is shown in FIG. 4. A rendered image 1000 shown in FIG. 4 includes a partial region 1100 at a predetermined position. Every time the trigger information is received, this partial region 1100 alternatively switches between “white” and “black”. Although, in the example shown in FIG. 4, the partial region 1100 is a region located at a lower right portion of the rendered image 1000, this is an example, and the partial region may be a region at any predetermined position in the rendered image. However, it is preferable that the partial region is located at a less noticeable position such as a lower right portion or a lower left portion of the rendered image.

The encoding instruction unit 222 of the rendering server 20 gives an instruction to encode the rendered image stored in the frame buffer 232. Then, the encoding unit 233 of the rendering server 20 encodes the rendered image stored in the frame buffer 232 and generates encoded information (step S108). This encoded information is stored in the VRAM 206.

The information transmission unit 202 of the rendering server 20 causes the VRAM readout unit 223 to read out the encoded information from the frame buffer 232, and transmits the encoded information to the user terminal 10 (step S109).

The decoding unit 108 of the user terminal 10 decodes the encoded information received by the information receiving unit 102 (step S110). Thus, the rendered image is stored in the frame buffer 109 (more specifically, the second layer buffer 122).

The frame buffer readout unit 111 of the user terminal 10 reads out the predetermined partial region (i.e., the partial region representing binary information that is “black” or “white”, for example) in the rendered image stored in the frame buffer 109 (step S111). Thus, a load of the user terminal 10 can be reduced compared with the case of reading out the entire rendered image. However, the invention is not limited to reading out the partial region in the rendered image. For example, a rendered image (or the partial region in this rendered image) may be read out for every predetermined number of frames, rather than reading out a rendered image of every frame.

The determination unit 112 of the user terminal 10 determines the binary information represented by the partial region read out in the above step S111 (step S112). That is to say, for example, the determination unit 112 determines whether the partial region represents “white” or “black”. At this time, for example, the determination unit 112 acquires the second time stamp from the clock 105. The second time stamp is information indicating the time at which the rendered image was displayed on the display unit 110 (more specifically, the time when the determination was performed by the determination unit 112), and is acquired from the clock 105, for example.

The information transmission unit 101 of the user terminal 10 transmits the result of the determination in the above step S112 and the second time stamp to the monitoring server 30 (step S113). Thus, in the monitoring server 30, the determination result and the second time stamp are stored in association with each other in the storing unit 305. However, the information transmission unit 101 may transmit the result of the determination in the above step S112 and the second time stamp to the monitoring server 30 only if the determination result differs from the previous determination result (i.e., if the previous determination result is “black” and the current determination result is “white”, or if the previous determination result is “white” and the current determination result is “black” etc.), for example. Thus, a communication load between the user terminal 10 and the monitoring server 30 can be reduced.

Note that a configuration may be employed in which, in the above step S113, if, for example, communication quality between the user terminal 10 and the monitoring server 30 is stable, the information transmission unit 101 does not transmit the second time stamp, and the second time stamp is generated and stored by the monitoring server 30 when the determination result is received, as in the above step S104. Thus, a communication load between the user terminal 10 and the monitoring server 30 can be reduced.

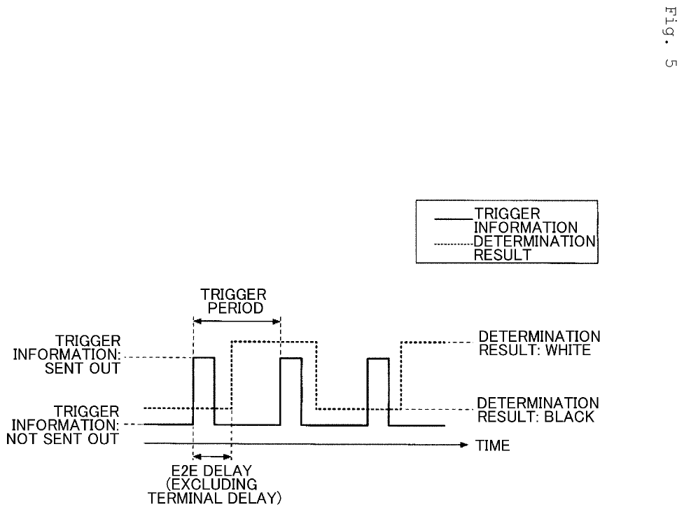

The display unit 304 of the monitoring server 30 displays a delay measurement result using the first time stamp, the determination result, and the second time stamp that are stored in the storing unit 305 (step S114). Here, an example of the delay measurement result is shown in FIG. 5. In the delay measurement result shown in FIG. 5, the time associated with the trigger information is indicated by a solid line, and the time associated with the determination result is indicated by a broken line. The time when the trigger information was sent out is represented by the first time stamp, and the determination result indicating “white” and the determination result indicating “black” are represented by the second time stamp. Thus, an E2E delay excluding a terminal delay is measured based on a difference between the time when the trigger information was sent out and the time when the determination result changed (in the example shown in FIG. 5, the time when the determination result changed from “black” to “white”). Accordingly, the user of the monitoring server 30 can perceive the E2E delay excluding the terminal delay.

Meanwhile, the display unit 110 of the user terminal 10 displays the rendered image stored in the frame buffer 109 (more specifically, the rendered image stored in the second layer buffer 122) by embedding the rendered image in the second layer 132 (step S115).

Although, in this embodiment, the partial region in the rendered image represents either value of the binary information, the invention is not limited thereto, and the partial region may alternatively represent any value of three or more-valued information. The image (partial region) representing the binary information is not limited to being a black or white image, and may alternately be, for example, a character, a pattern (e.g., a pattern representing code information such as a barcode), or the like. The same applies to the following embodiments.

### Embodiment 2

Next, a description will be given of the case as Embodiment 2 in which a network delay between the user terminal 10 and the rendering server 20 is measured. Note that the overall configuration is the same as that of Embodiment 1, and description thereof is omitted accordingly.

(Functional Configuration)

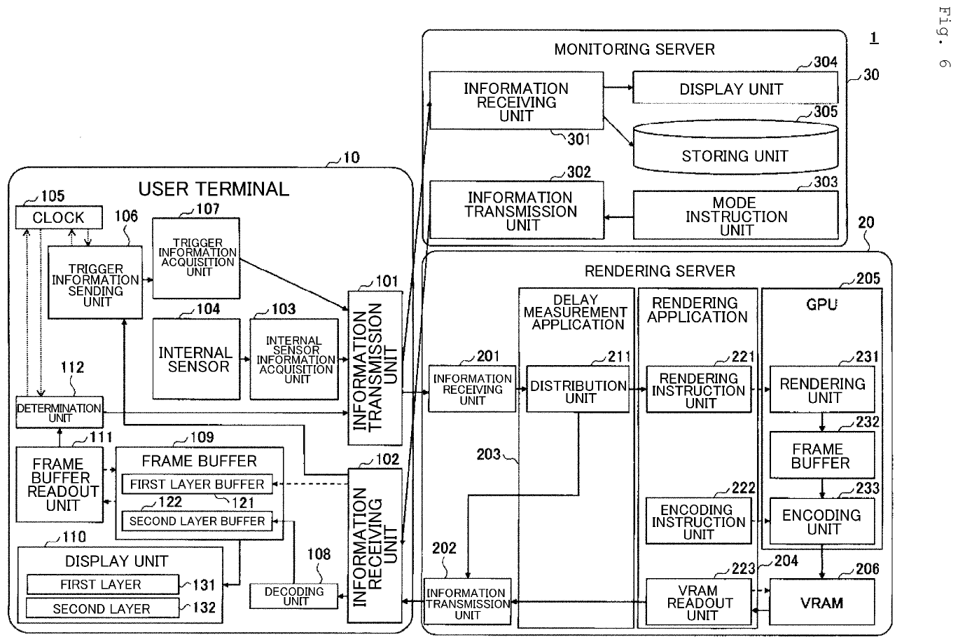

A functional configuration of the delay measurement system 1 according to Embodiment 2 will be described with reference to FIG. 6. FIG. 6 is a diagram for illustrating an example of the functional configuration of the delay measurement system 1 according to Embodiment 2. Note that Embodiment 2 will mainly describe differences from Embodiment 1.

In Embodiment 2, when the measurement mode is “measuring network delay”, the distribution unit 211 of the rendering server 20 performs return communication processing. In the return communication processing, the information transmission unit 202 transmits response information to the user terminal 10.

Further, in Embodiment 2, if the response information is received from the rendering server 20, the information receiving unit 102 of the user terminal 10 stores an image representing either value of binary information in the first layer buffer 121. Then, the frame buffer readout unit 111 reads out the image from the first layer buffer 121. Thus, it is determined by the determination unit 112 which value of the binary information is represented by the image.

(Flow of Delay Measurement Processing)

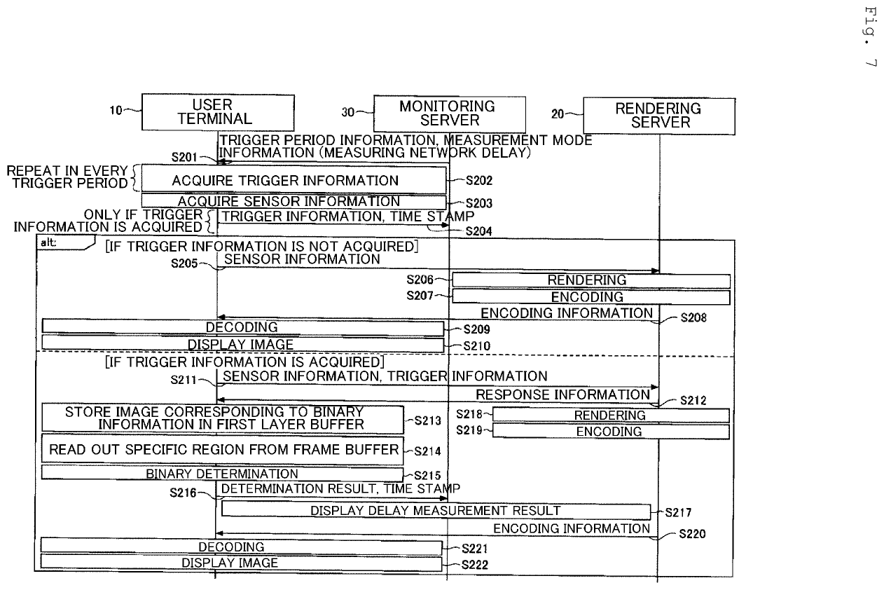

A flow of processing for measuring a delay (delay measurement processing) of Embodiment 2 will be described with reference to FIG. 7. FIG. 7 is a diagram for illustrating a flow of the delay measurement processing according to Embodiment 2.

The information transmission unit 302 of the monitoring server 30 transmits the measurement mode information and the trigger period information to the user terminal 10 in accordance with an instruction of the measurement mode and an instruction of the trigger period accepted by the mode instruction unit 303 (step S201). Here, in Embodiment 2, “measuring network delay” is set as the measurement mode. Thus, the measurement mode: “measuring network delay” and the trigger period, which is the period in which the trigger information sending unit 106 sends out the trigger information, are set to the user terminal 10.

The subsequent steps S202 to S204 are the same as steps S102 to S104 in FIG. 3, and description thereof is omitted accordingly.

If, in step S202, the trigger information is not acquired, the information transmission unit 101 transmits the sensor information acquired in step S203 to the rendering server 20 (step S205).

If the measurement mode is “measuring network delay”, the distribution unit 211 of the rendering server 20 transmits the sensor information received by the information receiving unit 201 as-is to the rendering application 204. Then, the rendering instruction unit 221 of the rendering server 20 gives a rendering instruction to the GPU 205 (step S206). Thus, an image from an eyepoint based on the sensor information is generated as a rendered image by the rendering unit 231, and is stored in the frame buffer 232.

The encoding instruction unit 222 of the rendering server 20 gives an instruction to encode the rendered image stored in the frame buffer 232. Then, the encoding unit 233 of the rendering server 20 encodes the rendered image stored in the frame buffer 232 and generates encoded information (step S207). This encoded information is stored in the VRAM 206.

The information transmission unit 202 of the rendering server 20 causes the VRAM readout unit 223 to read out the encoded information from the frame buffer 232, and transmits the encoded information to the user terminal 10 (step S208).

The decoding unit 108 of the user terminal 10 decodes the encoded information received by the information receiving unit 102 (step S209). Thus, the rendered image is stored in the frame buffer 109 (more specifically, the second layer buffer 122).

Then, the display unit 110 of the user terminal 10 displays the rendered image stored in the frame buffer 109 (more specifically, the rendered image stored in the second layer buffer 122) by embedding the rendered image in the second layer 132 (step S210).

On the other hand, if, in step S202, the trigger information is acquired, the information transmission unit 101 transmits the sensor information acquired in step S203 and the trigger information acquired in step S202 to the rendering server 20 (step S211). At this time, the information transmission unit 101 also transmits the measurement mode information to the rendering server 20. Note that the measurement mode information may be included in the trigger information (e.g., a flag indicating the measurement mode may be included in the trigger information).

If the measurement mode is “measuring network delay”, the distribution unit 211 of the rendering server 20 gives the information transmission unit 202 a notification for performing return communication processing. Thus, the information transmission unit 202 of the rendering server 20 transmits response information to the user terminal 10 (step S212).

Upon receiving the response information, the information receiving unit 102 of the user terminal 10 stores an image representing either value of the binary information in the first layer buffer 121 (step S213). Here, the information receiving unit 102 stores an image representing a value different from that of the previous binary information in the first layer buffer 121 (i.e., the information receiving unit 102 changes the binary information represented by the image). For example, if the image that has been stored immediately previously in the first layer buffer 121 is an image representing “white”, the information receiving unit 102 may store an image representing “black” in the first layer buffer 121. On the other hand, if, for example, the image that has been stored immediately previously in the first layer buffer 121 is an image representing “black”, the information receiving unit 102 may store an image representing “white” in the first layer buffer 121.

The frame buffer readout unit 111 of the user terminal 10 reads out the image stored in the first layer buffer 121 of the frame buffer 109 (or a predetermined partial region in this image) (step S214).

The determination unit 112 of the user terminal 10 determines the binary information represented by the image (or the partial region) read out in the above step S214 (step S215). That is to say, the determination unit 112 determines whether the image (or the partial region) represents “white” or “black”, for example. At this time, for example, the determination unit 112 acquires the second time stamp from the clock 105.

The information transmission unit 101 of the user terminal 10 transmits the result of the determination in the above step S215 and the second time stamp to the monitoring server 30 (step S216). Thus, in the monitoring server 30, the determination result and the second time stamp are stored in association with each other in the storing unit 305. However, the information transmission unit 101 may transmit the result of the determination in the above step S215 and the second time stamp to the monitoring server 30 only if the determination result differs from the previous determination result (i.e., if the previous determination result is “black” and the current determination result is “white”, or if the previous determination result is “white” and the current determination result is “black” etc.), for example. Thus, a communication load between the user terminal 10 and the monitoring server 30 can be reduced.

The display unit 304 of the monitoring server 30 displays a delay measurement result using the first time stamp, the determination result, and the second time stamp that are stored in the storing unit 305 (step S217). A network delay is measured based on a difference between the time when the trigger information was sent out (the time represented by the first time stamp) and the time when the determination result changed after the trigger information was sent out (the time represented by the second time stamp).

Note that the subsequent steps S218 to S222 are the same as the above steps S206 to S210, and description thereof is omitted accordingly.

### Embodiment 3

Next, a description will be given of the case as Embodiment 3 in which a delay excluding a terminal delay and an encoding/decoding delay (i.e., an E2E delay excluding a terminal delay and a delay occurring due to encoding and decoding) is measured. Note that the overall configuration is the same as that of Embodiment 1, and description thereof is omitted accordingly.

(Functional Configuration)

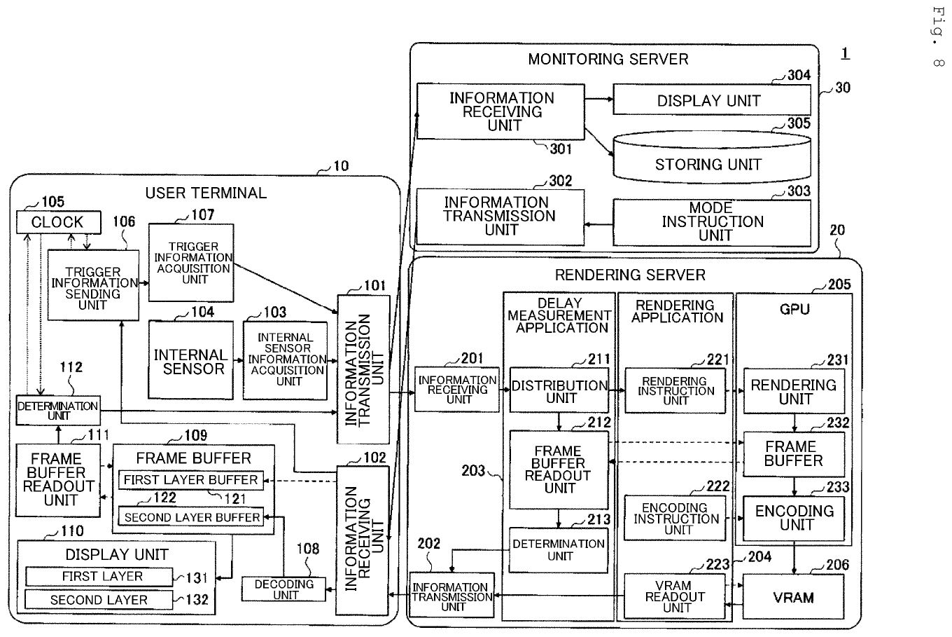

A functional configuration of the delay measurement system 1 according to Embodiment 3 will be described with reference to FIG. 8. FIG. 8 is a diagram for illustrating an example of the functional configuration of the delay measurement system 1 according to Embodiment 3. Note that Embodiment 3 will mainly describe differences from Embodiments 1 and 2.

In Embodiment 3, the delay measurement application 203 of the rendering server 20 includes a frame buffer readout unit 212 and a determination unit 213. In Embodiment 3, if the measurement mode is “delay excluding terminal delay and encoding/decoding delay”, the distribution unit 211 gives the frame buffer readout unit 212 an instruction to read out a predetermined partial region in a rendered image from the frame buffer 232. Thus, the frame buffer readout unit 212 reads out the predetermined partial region in the rendered image from the frame buffer 232.

Then, the determination unit 213 determines binary information represented by the partial region read out by the frame buffer readout unit 212. Thereafter, the determination result is transmitted to the user terminal 10 by the information transmission unit 202. Thus, in the user terminal 10, an image representing this determination result (i.e., an image representing either value of the binary information) is stored in the first layer buffer 121.

(Flow of Delay Measurement Processing)

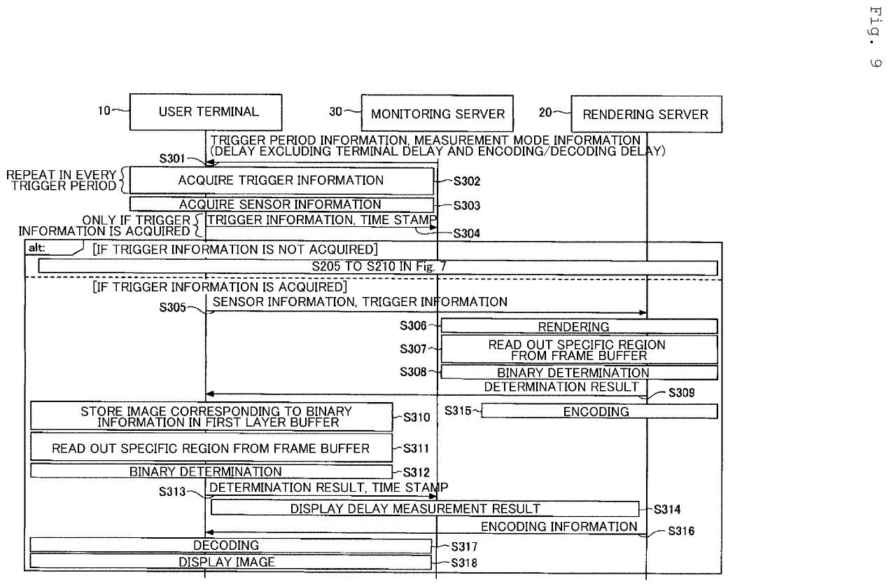

A flow of processing for measuring a delay (delay measurement processing) of Embodiment 3 will be described with reference to FIG. 9. FIG. 9 is a diagram for illustrating a flow of the delay measurement processing according to Embodiment 3.

The information transmission unit 302 of the monitoring server 30 transmits the measurement mode information and the trigger period information to the user terminal 10 in accordance with an instruction of the measurement mode and an instruction of the trigger period accepted by the mode instruction unit 303 (step S301). Here, in Embodiment 3, “delay excluding terminal delay and encoding/decoding delay” is set as the measurement mode. Thus, the measurement mode: “delay excluding terminal delay and encoding/decoding delay” and the trigger period, which is the period in which the trigger information sending unit 106 sends out the trigger information, are set to the user terminal 10.

The subsequent steps S302 to S304 are the same as steps S102 to S104 in FIG. 3, and description thereof is omitted accordingly. Processing in the case where the trigger information is not acquired in step S302 is the same as processing in steps S205 to S210 in FIG. 7, and description thereof is omitted accordingly.

If, in step S302, the trigger information is acquired, the information transmission unit 101 transmits the sensor information acquired in step S303 and the trigger information acquired in step S302 to the rendering server 20 (step S305). At this time, the information transmission unit 101 also transmits the measurement mode information to the rendering server 20. Note that the measurement mode information may be included in the trigger information (e.g., a flag indicating the measurement mode may be included in the trigger information).

If the measurement mode is “delay excluding terminal delay and encoding/decoding delay”, the distribution unit 211 of the rendering server 20 transmits the sensor information and the trigger information received by the information receiving unit 201 as-is to the rendering application 204. Then, the rendering instruction unit 221 of the rendering server 20 gives rendering instructions to the GPU 205 in accordance with the sensor information and the trigger information received by the information receiving unit 201 (step S306). Thus, a rendered image is generated and stored in the frame buffer 232.

Here, if the information receiving unit 201 receives the sensor information and the trigger information, the rendering instruction unit 221 gives, as the rendering instructions, an instruction to generate an image from a camera eyepoint based on the sensor information, and an instruction to perform processing to change binary information represented by a predetermined partial region in this image (i.e., if, for example, the partial region represents “black”, the binary information is changed to represent “white”, and if the partial region represents “white”, the binary information is changed to represent “black”).

The frame buffer readout unit 212 of the rendering server 20 reads out the predetermined partial region (i.e., the partial region representing binary information that is “black” or “white”, for example) in the rendered image stored in the frame buffer 232 (step S307).

The determination unit 213 of the rendering server 20 determines the binary information represented by the partial region read out in the above step S307 (step S308). That is to say, for example, the determination unit 112 determines whether the partial region represents “white” or “black”.

The information transmission unit 202 of the rendering server 20 transmits the result of the determination in the above step S308 to the user terminal 10 (step S309).

Upon receiving the determination result, the information receiving unit 102 of the user terminal 10 stores the image representing either value of the binary information in the first layer buffer 121 (step S310). Here, the information receiving unit 102 stores an image representing a value different from that of the previous binary information in the first layer buffer 121 (i.e., the information receiving unit 102 changes the binary information represented by the image). For example, if the image that has been stored immediately previously in the first layer buffer 121 is an image representing “white”, the information receiving unit 102 may store an image representing “black” in the first layer buffer 121. On the other hand, if, for example, the image that has been stored immediately previously in the first layer buffer 121 is an image representing “black”, the information receiving unit 102 may store an image representing “white” in the first layer buffer 121.

The subsequent steps S311 to S313 are the same as steps S214 to S216 in FIG. 7, and description thereof is omitted accordingly.

The display unit 304 of the monitoring server 30 displays a delay measurement result using the first time stamp, the determination result, and the second time stamp that are stored in the storing unit 305 (step S314). A delay excluding a terminal delay and an encoding/decoding delay is measured based on a difference between the time when the trigger information was sent out (the time represented by the first time stamp) and the time when the determination result changed after the trigger information was sent out (the time represented by the second time stamp).

The subsequent steps S315 to S318 are the same as steps S207 to S210 in FIG. 7, and description thereof is omitted accordingly.

### Embodiment 4

Next, a description will be given of the case as Embodiment 4 in which a terminal delay is measured. Note that, although the overall configuration is substantially the same as Embodiment 1, the delay measurement system 1 according to Embodiment 4 includes a signal transmission device 40 that transmits a signal indicating the trigger information, a light-receiving device 50 such as a light-receiving diode that receives light emitted by the display unit 110 of the user terminal 10, and a signal observation device 60 such as an oscilloscope that measures, as a delay, a difference between the signal transmitted by the signal transmission device 40 and a signal obtained from the light-receiving device 50.

(Functional Configuration)

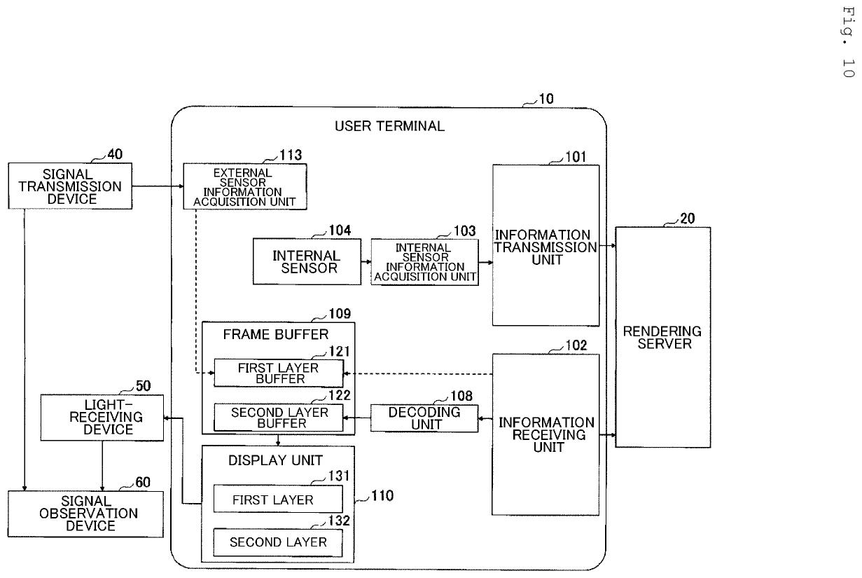

A functional configuration of the delay measurement system 1 according to Embodiment 4 will be described with reference to FIG. 10. FIG. 10 is a diagram for illustrating an example of the functional configuration of the delay measurement system 1 according to Embodiment 4.

In Embodiment 4, the user terminal 10 includes an external sensor information acquisition unit 113. The external sensor information acquisition unit 113 detects the signal transmitted from the signal transmission device 40 and acquires the signal as the trigger information. This signal (hereinafter also referred to as a “first signal”) is also transmitted to the signal observation device 60.

Upon acquiring the trigger information, the external sensor information acquisition unit 113 stores an image representing either value of binary information in the first layer buffer 121. Thus, this image is displayed on the first layer 131 of the display unit 110. As a result of the light-receiving device 50 receiving light emitted due to this display, a signal (hereinafter also referred to as a “second signal”) is transmitted from the light-receiving device 50 to the signal observation device 60.

(Flow of Delay Measurement Processing)

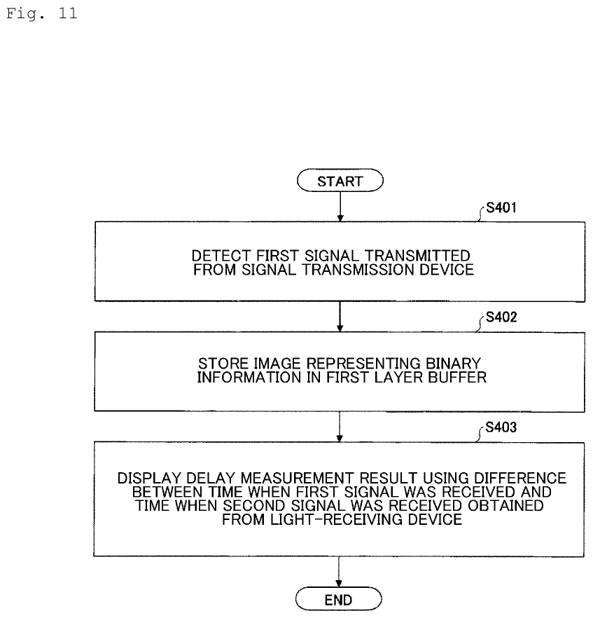

A flow of processing for measuring a delay (delay measurement processing) of Embodiment 4 will be described with reference to FIG. 11. FIG. 11 is a diagram for illustrating a flow of the delay measurement processing according to Embodiment 4.

The external sensor information acquisition unit 113 of the user terminal 10 detects (receives) the first signal transmitted by the signal transmission device 40 and acquires the first signal as the trigger information (step S401). At this time, the signal observation device 60 also detects (receives) the first signal and records the time of reception.

Upon acquiring the trigger information, the external sensor information acquisition unit 113 of the user terminal 10 stores an image representing either value of binary information in the first layer buffer 121 (step S402). Thus, this image is displayed on the first layer 131 of the display unit 110. The light-receiving device 50 transmits the second signal as a result of receiving light emitted due to this display (e.g., as a result of the light-receiving device 50 being brought into contact with a display or the like of the user terminal 10). The second signal is received by the signal observation device 60, and the time of reception is recorded.

The signal observation device 60 displays the result of measuring the delay while regarding a difference between the time when the second signal was received and the time when the first signal was received as a terminal delay (step S403). Thus, the terminal delay is measured and displayed.

Note that this embodiment is carried out when a terminal delay is measured in advance, for example. Since the terminal delay does not change from time to time, for example, the terminal delay may be measured in advance for each type of user terminal 10, and the measurement results may be stored in a database or the like. The thus-measured terminal delay can be added to the measurement results or the like in Embodiments 1 to 3 when in use, for example.

### Embodiment 5

Next, a description will be given of the case as Embodiment 5 in which a terminal delay is measured using a speaker and a microphone. Note that although the overall configuration is substantially the same as Embodiment 4, the delay measurement system 1 according to Embodiment 5 further includes a sound collection device 70, such as a microphone.

(Functional Configuration)

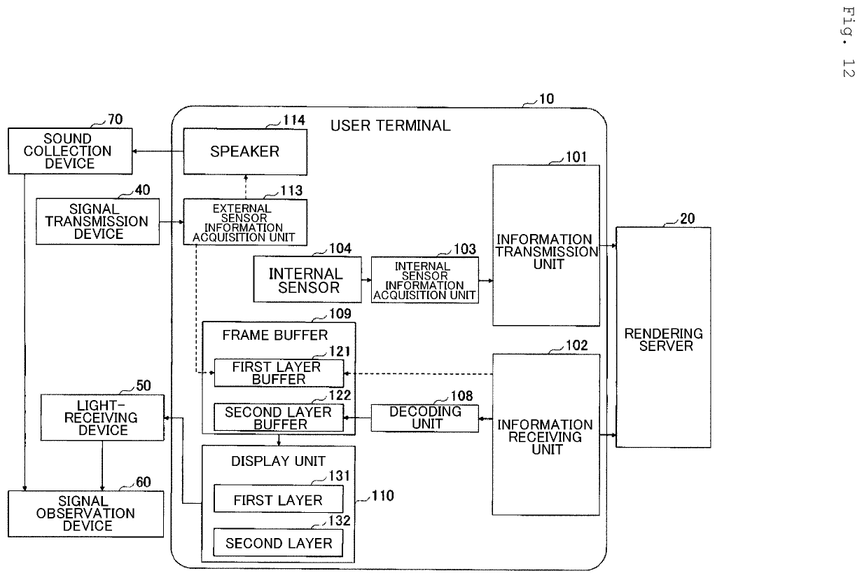

A functional configuration of the delay measurement system 1 according to Embodiment 5 will be described with reference to FIG. 12. FIG. 12 is a diagram for illustrating an example of the functional configuration of the delay measurement system 1 according to Embodiment 5.

In Embodiment 5, the user terminal 10 includes a speaker 114. Upon the trigger information being acquired by the external sensor information acquisition unit 113, the speaker 114 outputs a sound such as a beep sound, for example. Note that in Embodiment 5, a delay of the speaker 114 between when the trigger information is acquired and when the sound is output is known or negligibly small compared with a terminal delay.

(Flow of Delay Measurement Processing)

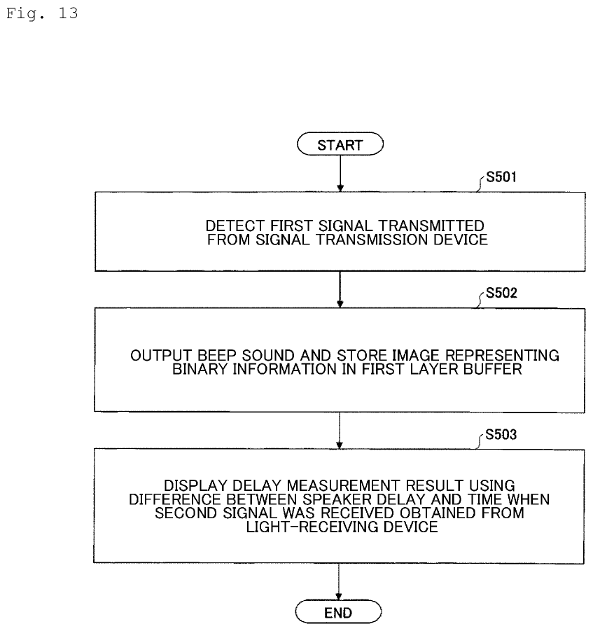

A flow of processing for measuring a delay (delay measurement processing) of Embodiment 5 will be described with reference to FIG. 13. FIG. 13 is a diagram for illustrating a flow of the delay measurement processing according to Embodiment 5.

The external sensor information acquisition unit 113 of the user terminal 10 detects (receives) the first signal transmitted by the signal transmission device 40 and acquires the first signal as the trigger information (step S501).

Upon acquiring the trigger information, the external sensor information acquisition unit 113 of the user terminal 10 causes a beep sound to be output from the speaker 114, and stores an image representing either value of binary information in the first layer buffer 121 (step S502). Thus, a signal is output from the sound collection device 70 that receives the input of the beep sound, and the signal observation device 60 detects (receives) this signal and records the time of reception. Also, the image is displayed on the first layer 131 of the display unit 110, and the light-receiving device 50 transmits the second signal as a result of receiving light emitted due to the display. The second signal is received by the signal observation device 60, and the time of reception is recorded.

The signal observation device 60 displays the result of measuring the delay while regarding a difference between the time when the second signal was received and the time when the signal from the speaker 114 was received as a terminal delay (step S503). Thus, the terminal delay is measured and displayed.

Note that this embodiment is carried out when a terminal delay is measured in advance, for example, as with Embodiment 4. Since the terminal delay does not change from time to time, for example, the terminal delay may be measured in advance for each type of user terminal 10, and the measurement results may be stored in a database or the like. The thus-measured terminal delay can be added to the measurement results or the like in Embodiments 1 to 3 when in use, for example.

### Embodiment 6

Next, a description will be given of the case as Embodiment 6 in which an E2E delay excluding a terminal delay is measured by adding a time stamp to all (or some) pieces of sensor information, without using the trigger information. By adding a time stamp to all (or some) pieces of the sensor information, the volume of data transmitted from the user terminal 10 increases but the sensor information can then be associated with a rendered image, and thus, more detailed delay measurement is enabled. Note that the overall configuration is the same as that of Embodiment 1, and description thereof is omitted accordingly.

(Functional Configuration)

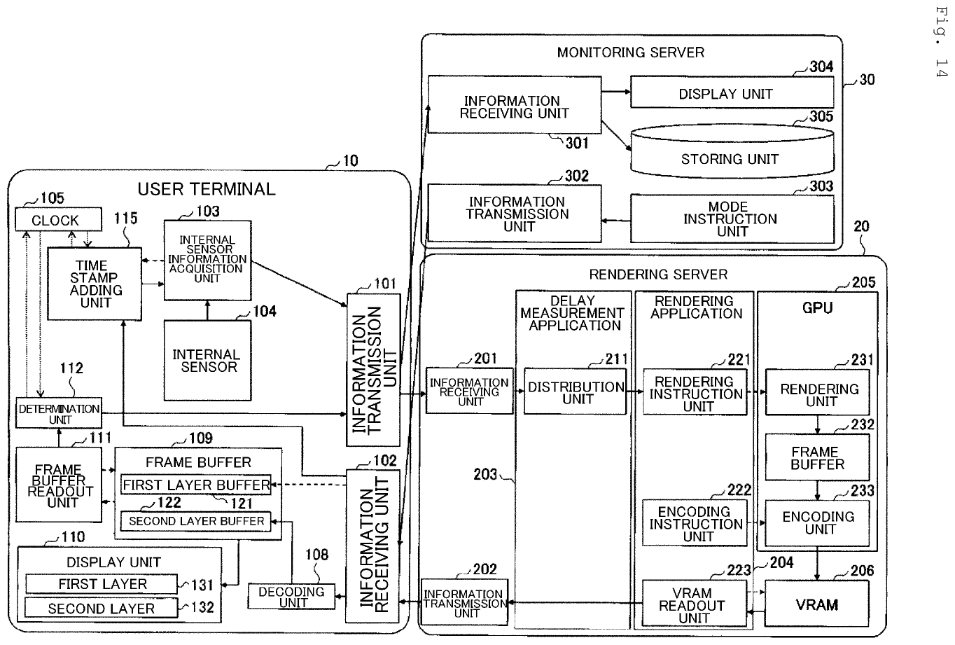

A functional configuration of the delay measurement system 1 according to Embodiment 6 will be described with reference to FIG. 14. FIG. 14 is a diagram for illustrating an example of the functional configuration of the delay measurement system 1 according to Embodiment 6. Note that Embodiment 6 will mainly describe differences from Embodiment 1.

In Embodiment 6, the user terminal 10 does not include the trigger information sending unit 106 and the trigger information acquisition unit 107, but includes a time stamp adding unit 115. The time stamp adding unit 115 adds a time stamp to the sensor information acquired by the internal sensor information acquisition unit 103. Thus, the time stamp is added to all (or some) pieces of the sensor information.

(Flow of Delay Measurement Processing)

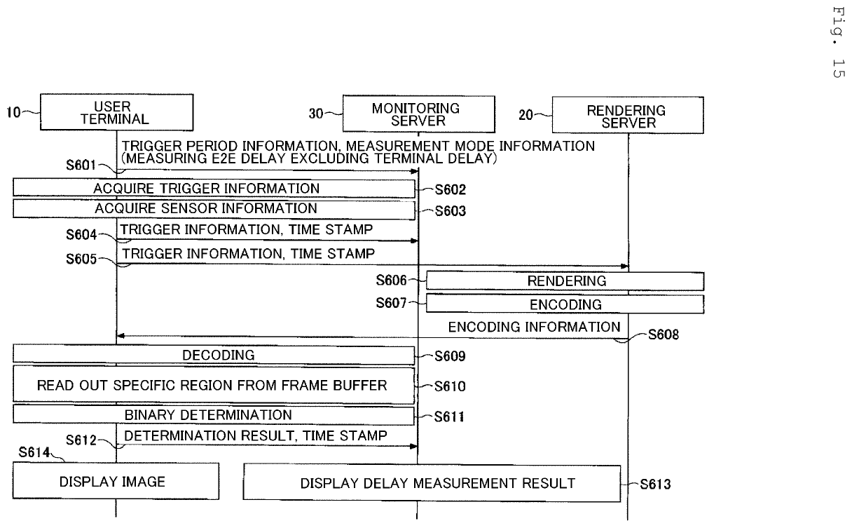

A flow of processing for measuring a delay (delay measurement processing) of Embodiment 6 will be described with reference to FIG. 15. FIG. 15 is a diagram for illustrating a flow of the delay measurement processing according to Embodiment 6.

The information transmission unit 302 of the monitoring server 30 transmits the measurement mode information to the user terminal 10 in accordance with an instruction of the measurement mode accepted by the mode instruction unit 303 (step S601). Here, in Embodiment 6, “measuring E2E delay excluding terminal delay” is set as the measurement mode. Thus, the measurement mode: “measuring E2E delay excluding terminal delay” is set to the user terminal 10.

The internal sensor information acquisition unit 103 of the user terminal 10 acquires the sensor information from the internal sensor 104 (step S602).

The time stamp adding unit 115 of the user terminal 10 adds a time stamp to the sensor information acquired in the above step S602 (step S603). Note that the time stamp adding unit 115 may add the time stamp to all pieces of the sensor information acquired in the above step S602, or may add the time stamp only to some pieces of the sensor information (e.g., the sensor information acquired from some internal sensors 104 etc.). The time stamp adding unit 115 may also add, for example, a serial number that monotonously increases, in addition to the time stamp, to the sensor information. As a result of such a serial number being added to the sensor information, for example, sensor information that is discarded in the communication network N, sensor information that is discarded at the rendering unit 231, or the like can be tracked later.

The information transmission unit 101 of the user terminal 10 transmits, to the monitoring server 30, the sensor information acquired in the above step S602 and the time stamp added in the above step S603 (step S604). In the monitoring server 30, the sensor information and the time stamp are stored in association with each other in the storing unit 305. Here, the time stamp is information indicating the time when the sensor information was transmitted to the monitoring server 30, and can be acquired from the clock 105, for example.

Note that a configuration may be employed in which if, for example, communication quality between the user terminal 10 and the monitoring server 30 is stable, in the above step S604, the information transmission unit 101 does not transmit the time stamp, but the time stamp is generated and stored by the monitoring server 30 when the sensor information is received. Thus, a communication load between the user terminal 10 and the monitoring server 30 can be reduced.

The information transmission unit 101 of the user terminal 10 transmits, to the rendering server 20, the sensor information acquired in the above step S602 and the time stamp added in the above step S603 (step S605). At this time, the information transmission unit 101 also transmits the measurement mode information to the rendering server 20.

If the measurement mode is “measuring E2E delay excluding terminal delay”, the distribution unit 211 of the rendering server 20 transmits the sensor information and the time stamp received by the information receiving unit 201 as-is to the rendering application 204. Then, the rendering instruction unit 221 of the rendering server 20 gives rendering instructions to the GPU 205 in accordance with the sensor information and the time stamp received by the information receiving unit 201 (step S606). Thus, a rendered image is generated and stored in the frame buffer 232.

Here, the rendering instruction unit 221 gives, as the rendering instructions, an instruction to generate an image from a camera eyepoint based on the sensor information and an instruction to perform processing to change information represented by a predetermined partial region in the image in accordance with the time stamp. This processing may be, for example, image processing for causing the time stamp, the serial number, or the like to be displayed as-is on the partial region, or image processing for causing a bit pattern (e.g. a barcode etc.) representing the time stamp, the serial number, or the like to be displayed on the partial region.

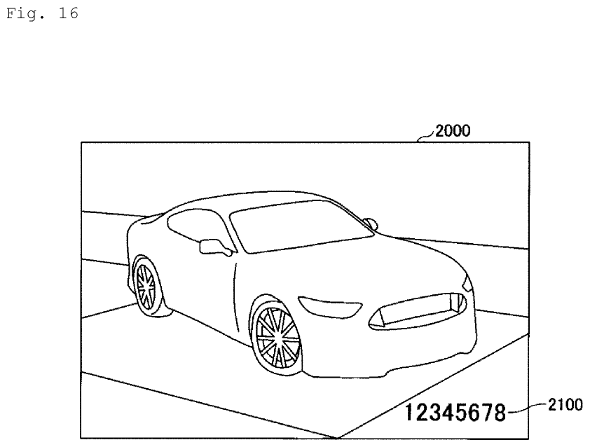

Thus, a rendered image that includes the partial region representing information corresponding to the time stamp (or the serial number etc.) is generated. Here, an example of the rendered image obtained as a result of the rendering in the above step S606 is shown in FIG. 16. A rendered image 2000 shown in FIG. 16 includes a partial region 2100 at a predetermined position. This partial region 2100 includes an image representing information corresponding to the time stamp (or the serial number etc.). The example shown in FIG. 16 includes an image representing “12345678” as an image representing information that is also visible to a person.

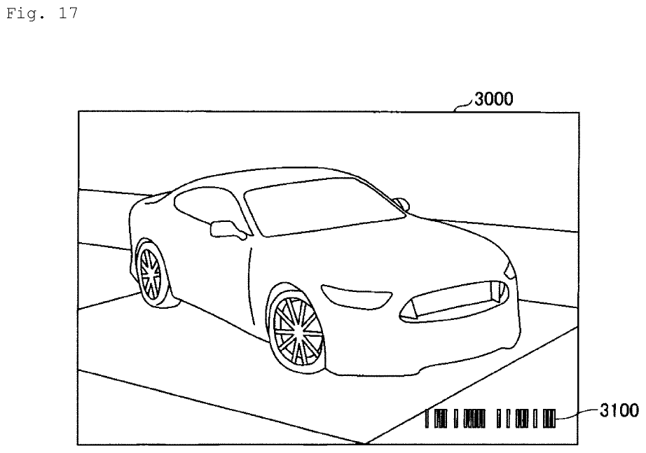

Another example of the rendered image obtained as a result of the rendering in the above step S606 is shown in FIG. 17. A rendered image 3000 shown in FIG. 17 includes a partial region 3100 at a predetermined position. This partial region 3100 includes an image representing information corresponding to the time stamp (or the serial number etc.). The example shown in FIG. 17 includes a bit pattern representing information that can be acquired by being mechanically read.

Although, in the examples shown in FIGS. 16 and 17, the partial region is a region located at a lower right portion of the rendered image, this is an example, and the partial region may be a region at any predetermined position in the rendered image. However, the partial region is preferably located at a less noticeable position such as a lower right portion or a lower left portion of the rendered image.

The subsequent steps S607 to S609 are the same as steps S108 to S110 in FIG. 3, and description thereof is omitted accordingly.

The frame buffer readout unit 111 of the user terminal 10 reads out the predetermined partial region in the rendered image stored in the frame buffer 109 (step S610). Thus, a load of the user terminal 10 can be reduced compared with the case of reading out the entire rendered image. However, the invention is not limited to the case of reading out the partial region in the rendered image. For example, a rendered image (or the partial region in this rendered image) may be read out for every predetermined number of frames, rather than reading out a rendered image of every frame.

The determination unit 112 of the user terminal 10 determines information represented by the partial region read out in the above step S610 (step S611). At this time, for example, the determination unit 112 acquires the second time stamp from the clock 105. Note that, to reduce the processing load of the user terminal 10, the determination of the information represented by the partial region may be performed by the rendering server 20, for example.

The information transmission unit 101 of the user terminal 10 transmits the result of the determination in the above step S611 and the second time stamp to the monitoring server 30 (step S612). Thus, in the monitoring server 30, the determination result and the second time stamp are stored in association with each other in the storing unit 305.

Note that a configuration may be employed in which, in the above step S612, if, for example, communication quality between the user terminal 10 and the monitoring server 30 is stable, the information transmission unit 101 does not transmit the second time stamp, but the second time stamp is generated and stored by the monitoring server 30 when the determination result is received, as in the above step S604. Thus, a communication load between the user terminal 10 and the monitoring server 30 can be reduced.

The display unit 304 of the monitoring server 30 displays a delay measurement result using the sensor information and the time stamp thereof, the determination result, and the second time stamp that are stored in the storing unit 305 (step S613). In Embodiment 6, an E2E delay excluding a terminal delay is measured based on the difference between the time when the determination result changed (i.e., the time represented by the second time stamp) and the time represented by the time stamp added to the sensor information.

Meanwhile, the display unit 110 of the user terminal 10 displays the rendered image stored in the frame buffer 109 (more specifically, the rendered image stored in the second layer buffer 122) by embedding the rendered image in the second layer 132 (step S614).

### Embodiment 7

Next, a description will be given of the case as Embodiment 7 in which a delay is measured using a plurality of network devices 90 arranged between the user terminal 10 and the rendering server 20. Note that, in Embodiment 7, a plurality of network devices 90 (e.g. a router, a gateway, a switch etc.) are installed between the user terminal 10 and the rendering server 20. At least one of the plurality of network devices 90 and the rendering server 20 are realized by a virtual machine on a virtualization infrastructure 80. In the following description, the network device 90 realized by the virtual machine on the virtualization infrastructure 80 is also referred to as a “network device 85”. Note that, in Embodiment 7, the network devices 90 and the monitoring server 30 are located within the same carrier's network, and the time is synchronized therebetween, for example.

(Functional Configuration)

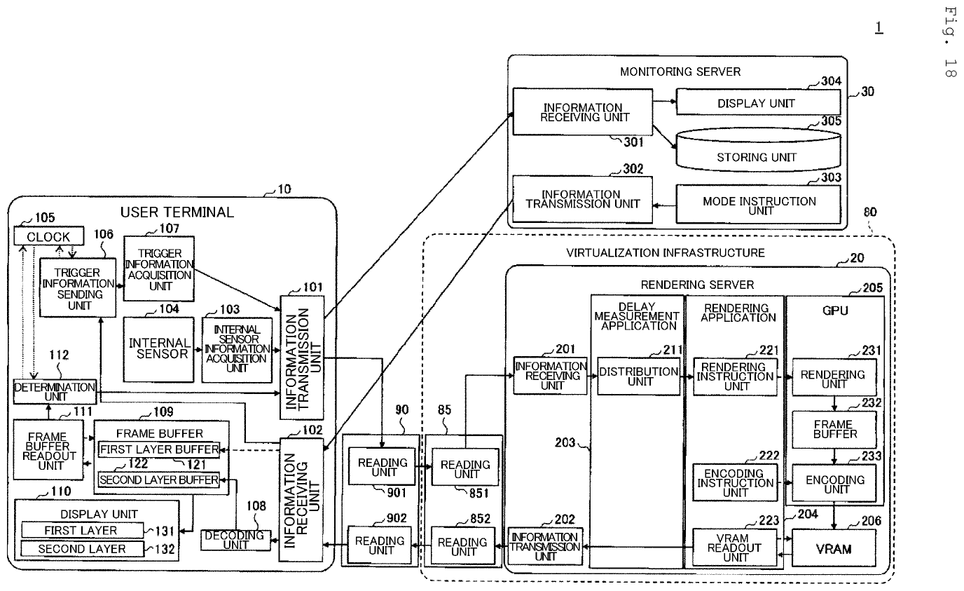

A functional configuration of the delay measurement system 1 according to Embodiment 7 will be described with reference to FIG. 18. FIG. 18 is a diagram for illustrating an example of the functional configuration of the delay measurement system according to Embodiment 7.

In Embodiment 7, each network device 90 includes a reading unit 901 and a reading unit 902. Each network device 85 includes a reading unit 851 and a reading unit 852.

If the trigger information transmitted from the user terminal 10 is received, the reading unit 901 transmits the time of reception to the monitoring server 30. Meanwhile, if information (e.g., encoded information) from the rendering server 20 is received, the reading unit 902 transmits the time of reception to the monitoring server 30. The above time of reception is stored in the storing unit 305 of the monitoring server 30.

Similarly, if the trigger information transmitted from the user terminal 10 is received, the reading unit 851 transmits the time of reception to the monitoring server 30. Meanwhile, if information (e.g., encoded information) from the rendering server 20 is received, the reading unit 852 transmits the time of reception to the monitoring server 30. The above time of reception is stored in the storing unit 305 of the monitoring server 30.

With the above configuration, in Embodiment 7, the time when the trigger information, the encoded information, or the like passes through the network devices 90 (including the network device 85) can be held in the monitoring server 30. Thus, for example, the time of passage through the network devices 90 can be compared, and a delay can be measured.

[Hardware Configuration]

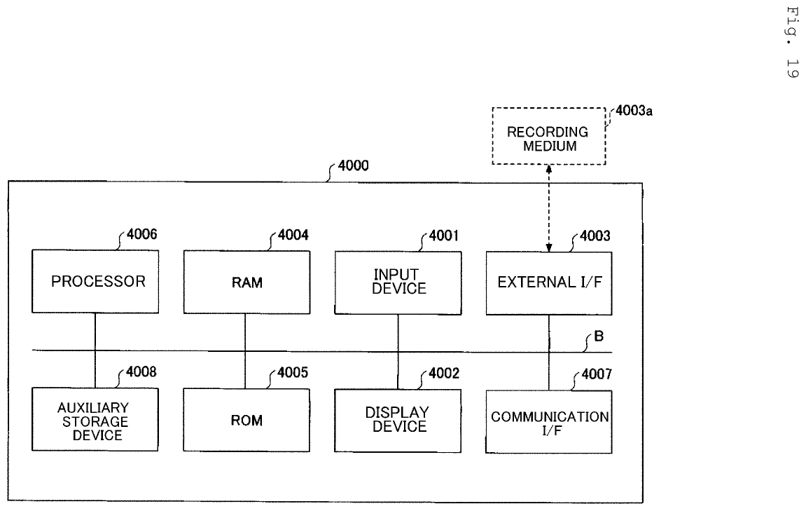

Lastly, each of the user terminal 10, the rendering server 20, and the monitoring server 30 in the above embodiments can be realized by using a computer 4000 with a hardware configuration such as that shown in FIG. 19, for example. FIG. 19 shows an example of the hardware configuration of the computer 4000.

The computer 4000 shown in FIG. 19 has an input device 4001, a display device 4002, an external I/F 4003, a RAM (Random Access Memory) 4004, a ROM (Read Only Memory) 4005, a processor 4006, a communication I/F 4007, and an auxiliary storage device 4008. These pieces of hardware are communicably connected to each other via a bus B.

The input device 4001 is, for example, a keyboard, a mouse, a touch panel, or the like. The display device 4002 is, for example, a display or the like. Note that at least either the input device 4001 or the display device 4002 need not be included in the rendering server 20.

The external I/F 4003 is an interface for an external device. The external device may be, for example, a recording medium 4003a such as a CD (Compact Disc), a DVD (Digital Versatile Disk), an SD memory card (Secure Digital memory card), or a USB (Universal Serial Bus) memory card.

The RAM 4004 is a volatile semiconductor memory for temporarily holding programs and data. The ROM 4005 is a nonvolatile semiconductor memory capable of holding programs and data even after power is turned off. For example, setting information related to an OS (Operating System), setting information for connecting to the communication network N, or the like is stored in the ROM 4005.

The processor 4006 is, for example, a CPU (Central Processing Unit), a GPU, or the like, and is a computing device that loads programs and data from the ROM 4005, the auxiliary storage device 4008, or the like to the RAM 4004 and executes processing.

The communication I/F 4007 is an interface for connecting to the communication network N. The auxiliary storage device 4008 is, for example, an HDD (Hard Disk Drive), an SSD (Solid State Drive), or the like, and is a nonvolatile storage device that stores programs and data. The programs and data stored in the auxiliary storage device 4008 include, for example, an OS, application programs that realize various functions on the OS, one or more programs that realize the above embodiments, or the like.

The user terminal 10, the rendering server 20, and the monitoring server 30 in the above embodiments can realize the above-described various kinds of processing by means of the hardware configuration of the computer 4000 shown in FIG. 19. Note that the rendering server 20 and the monitoring server 30 may be realized by a plurality of computers. One computer may include a plurality of processors 4006 and a plurality of memories (RAMS 4004, ROMs 4005, auxiliary storage devices 4008 etc.).

The present invention is not limited to the above embodiment that has been specifically disclosed, and various variations, modifications, combinations, or the like can be made without departing from the scope of claims.

### REFERENCE SIGNS LIST

1 Delay measurement system
10 User terminal
20 Rendering server
30 Monitoring server
101 Information transmission unit
102 Information receiving unit
103 Internal sensor information acquisition unit
104 Internal sensor
105 Clock
106 Trigger information sending unit
107 Trigger information acquisition unit
108 Decoding unit
109 Frame buffer
110 Display unit
111 Frame buffer readout unit
112 Determination unit
201 Information receiving unit
202 Information transmission unit
203 Delay measurement application
204 Rendering application
205 GPU
206 VRAM
211 Distribution unit
221 Rendering instruction unit
222 Encoding instruction unit
223 VRAM readout unit
231 Rendering unit
232 Frame buffer
233 Encoding unit
N Communication network

1. A delay measurement device that is to be connected, via a communication network, to a rendering server that performs rendering processing on an image, the device comprising:
a transmission unit, including one or more processors, configured to transmit, to the rendering server, sensor information acquired from a sensor included in the delay measurement device and trigger information acquired in a predetermined time period;
a receiving unit, including one or more processors, configured to receive a rendered image generated through the rendering processing performed in the rendering server based on the sensor information and the trigger information; and
a signal measurement device configured to measure a predetermined delay based on a difference between a first time indicating a time when the trigger information was transmitted to the rendering server and a second time indicating a time when the rendered image or a predetermined image was displayed.

2. The delay measurement device according to claim 1,
wherein, in the rendering processing, information represented by a predetermined partial region included in the rendered image is changed based on the trigger information, and
the signal measurement device is configured to measure an end-to-end delay excluding a delay associated with the display based on the difference between the first time and the second time, the second time being a time when the information represented by the partial region included in the rendered image changed.

3. The delay measurement device according to claim 1,
wherein the rendering server is configured to transmit, to the delay measurement device, a determination result of determining whether or not information represented by a predetermined partial region included in the rendered image has changed, before the rendered image is encoded, and
the signal measurement device is configured to measure an end-to-end delay excluding a delay associated with the display and a delay associated with the encoding and decoding, based on the difference between the first time and the second time, the second time being a time when an image based on the determination result was displayed.

4. The delay measurement device according to claim 1,
wherein the rendering server is configured to, upon receiving the trigger information, transmit response information to the delay measurement device, and
the signal measurement device is configured to measure a network delay based on the difference between the first time and the second time, the second time being a time when an image based on the response information was displayed.

5. A delay measurement method for a delay measurement device that is connected, via a communication network, to a rendering server that performs rendering processing on an image, the method comprising:
a transmission step of transmitting, to the rendering server, sensor information acquired from a sensor included in the delay measurement device and trigger information acquired in a predetermined time period;
a receiving step of receiving a rendered image generated through the rendering processing performed in the rendering server based on the sensor information and the trigger information; and
a measurement step of measuring a predetermined delay based on a difference between a first time indicating a time when the trigger information was transmitted to the rendering server and a second time indicating a time when the rendered image or a predetermined image was displayed.

6. A non-transitory computer readable medium storing a program for causing a computer to function as a delay measurement to perform:
a transmission step of transmitting, to the rendering server, sensor information acquired from a sensor included in the delay measurement device and trigger information acquired in a predetermined time period;
a receiving step of receiving a rendered image generated through the rendering processing performed in the rendering server based on the sensor information and the trigger information; and
a measurement step of measuring a predetermined delay based on a difference between a first time indicating a time when the trigger information was transmitted to the rendering server and a second time indicating a time when the rendered image or a predetermined image was displayed.

7. The delay measurement method according to claim 5, wherein:
in the rendering processing, information represented by a predetermined partial region included in the rendered image is changed based on the trigger information, and
the measurement step comprises measuring an end-to-end delay excluding a delay associated with the display based on the difference between the first time and the second time, the second time being a time when the information represented by the partial region included in the rendered image changed.

8. The delay measurement method according to claim 5, wherein:
the rendering server is configured to transmit, to the delay measurement device, a determination result of determining whether or not information represented by a predetermined partial region included in the rendered image has changed, before the rendered image is encoded, and
the measurement step comprises measuring an end-to-end delay excluding a delay associated with the display and a delay associated with the encoding and decoding, based on the difference between the first time and the second time, the second time being a time when an image based on the determination result was displayed.

9. The delay measurement method according to claim 5, wherein:
the rendering server is configured to, upon receiving the trigger information, transmit response information to the delay measurement device, and
the measurement step comprises measuring a network delay based on the difference between the first time and the second time, the second time being a time when an image based on the response information was displayed.

10. The non-transitory computer readable medium according to claim 6, wherein:
in the rendering processing, information represented by a predetermined partial region included in the rendered image is changed based on the trigger information, and
the measurement step comprises measuring an end-to-end delay excluding a delay associated with the display based on the difference between the first time and the second time, the second time being a time when the information represented by the partial region included in the rendered image changed.

11. The non-transitory computer readable medium according to claim 6, wherein:
the rendering server is configured to transmit, to the delay measurement device, a determination result of determining whether or not information represented by a predetermined partial region included in the rendered image has changed, before the rendered image is encoded, and
the measurement step comprises measuring an end-to-end delay excluding a delay associated with the display and a delay associated with the encoding and decoding, based on the difference between the first time and the second time, the second time being a time when an image based on the determination result was displayed.

12. The non-transitory computer readable medium according to claim 6, wherein:
the rendering server is configured to, upon receiving the trigger information, transmit response information to the delay measurement device, and
the measurement step comprises measuring a network delay based on the difference between the first time and the second time, the second time being a time when an image based on the response information was displayed.
